(19) United States
(12) Patent Application Publication
(10) Pub. No.: US 2024/0112601 A1
(43) Pub. Date: Apr. 4, 2024

(54) Neonate IV Catheter Trainer

(71) Applicant: THE CURATORS OF THE UNIVERSITY OF MISSOURI, COLUMBIA, MO (US)

(72) Inventor: Damon Coyle, Columbia, MO (US)

(21) Appl. No.: 18/264,139

(22) PCT Filed: Feb. 11, 2022
(86) PCT No.: PCT/US2022/016066

§ 371 Date: Aug. 3, 2023

Related U.S. Application Data
(60) Provisional application No. 63/152,591, filed on Feb. 23, 2021.

(51) Int. Cl. G09B 23/28; G09B 23/30

(52) U.S. Cl. CPC G09B 23/285; G09B 23/303

(57) ABSTRACT

A neonate intravenous (IV) training module for practicing critical nursing skills, wherein the training module comprises an inner core structured to have the size and shape of a neonate appendage, the inner core comprising at least one shallow blood vessel channel formed therein. The training module additionally comprises a removable outer skin glove structured to have the size and appearance of a neonate appendage, the outer skin glove being removably disposable over at least a portion the inner core. The training module further comprises at least one flexible blood vessel tubing that is removably disposable within the at least one blood vessel channel, and the at least one flexible tubing structure to have an outer diameter and wall thickness of a neonate blood vessel.

### CROSS-REFERENCE TO RELATED APPLICATIONS

The present application is the US national stage under 35 U.S.C. § 371 of International Application No. PCT/US2022/016066 which was filed on Feb. 11, 2022, and which claims the priority of U.S. Provisional Application No. 63/152,591, filed on Feb. 23, 2021. The disclosure of the above application is incorporated herein by reference in its/their entirety.

### FIELD

The present teachings relate to medical neonate training devices, and more particularly to an educational training tool for providing healthcare professionals with a realistic human tissue analogue to practice the critical intravenous (IV) nursing skills.

### BACKGROUND

The statements in this section merely provide background information related to the present disclosure and may not constitute prior art.

The neonatal patient population poses unique challenges in care delivery due to their small size and delicate anatomy. Current solutions to such challenges do not widely cater to this patient subset, as it makes up a relatively small percentage of the overall population. For example, current devices for pediatric vascular access training do not cater to this young of a patient population and are typically reflective of a toddler and thus significantly larger in size. Departments such as neonatal intensive care units (NICUs) have relented to using these substandard devices, as superior solutions are unavailable.

For example, prior to graduating nursing school, nursing education does not usually involve the neonate patient demographic due to the institutions' lack of resources in time and funding in spite of the continued need for competency in performing procedures, such as intravenous (IV) catheterization, IV flush, transillumination of vessels, PICC line insertion, and arterial blood gas sampling, on neonate patients. Typically, nursing students and practicing nurses will be limited to practicing IV administration via adult or pediatric task trainers which are much larger in size than actual neonates and not optimal in facilitating the skills required for a much smaller neonatal patient. Moreover, the vast majority of neonatal registered nurses actively caring for newborns in the hospital setting do not have access to training devices that adequately reflect the unique characteristics of this patient population.

They instead adopt a philosophy of learning in which an inexperienced nurse observes an experienced nurse perform intravenous catheterization on a neonate, after which the inexperienced observer is expected to perform a successful IV catheterization on either the same or another newborn. This training method is not suited for successive and repetitive procedural task training and is fraught with potential complications because the procedure can typically only be performed once, the patient is subjected to unneeded (and unskillfully placed) needle sticks, and the learner is likely expected to perform the task under scrutiny of anxious parents. Furthermore, NICUs employ IV administration techniques unique to this patient population, such as hyperflexion of the patient's wrist, and known task trainers do not allow for training of such techniques.

Furthermore, known task trainer for toddler size and larger patients are often constructed of inferior materials such as vinyl or polyurethane rubbers. While cost-effective to mass produce, task trainers made from these materials lack a realistic feel and do not compare to actual haptics of a human neonate.

### SUMMARY

The present disclosure generally provides an educational neonatal training device (task trainer) for providing healthcare students and professionals (referred to herein as healthcare learners) with a realistic human neonate size and tissue analogue to practice the critical nursing skills of IV catheterization, IV flush, transillumination of vessels, PICC line insertion, IV dressing administration, and arterial blood gas sampling for neonatal patients. Using the presently disclosed task trainer, healthcare learners can improve their skills and validate competency on a hyper-realistic task trainer well before attempting these skills on a live neonatal patient, thus improving confidence in technique and reducing negative patient outcomes in a controlled, repeatable environment. The role of realistic simulation in neonatal vascular task trainers, such as those disclosed herein, is very important in the education and competency of clinical healthcare professionals. By offering devices as real-to-life as possible, task trainers can provide superior training compared to level of training when using known simulation solutions.

For example, in various embodiments the present disclosure provides a neonate intravenous (IV) training module for practicing critical nursing skills, wherein the training module comprises an inner core structured to have the size and shape of a neonate appendage, and the inner core comprises at least one shallow blood vessel channel formed therein. In such embodiments the training module additionally comprises a removable outer skin glove structured to have the size and appearance of a neonate appendage, and the outer skin glove being removably disposable over at least a portion the inner core. In such embodiments the training module further comprises at least one flexible blood vessel tubing that is removably disposable within the at least one blood vessel channel, and the at least one flexible tubing structure to have an outer diameter and wall thickness of a neonate blood vessel.

For example, in various other embodiments the present disclosure provides a neonate intravenous (IV) task trainer system for practicing critical nursing skills, wherein the system comprises a neonate IV training module that is structured to have the size and appearance of neonate appendage. In such embodiments the IV training module comprises an inner core that comprises at least one shallow blood vessel channel formed therein, and a removable outer skin glove that is removably disposable over at least a portion the inner core. In such embodiments the system additionally comprises a fluid supply module that is removably and fluidly connectable to the IV training module, and at least one flexible blood vessel tubing that is removably disposable within the at least one blood vessel channel, and the at least one flexible tubing structure to have an outer diameter and wall thickness of a neonate blood vessel.

For example, in yet other embodiments the present disclosure provides a neonate intravenous (IV) task trainer system for practicing critical nursing skills, wherein the system comprising a neonate IV training module that is structured to have the size and appearance of neonate appendage. In various embodiments the IV training module comprises an inner core that comprises at least one shallow blood vessel channel 30 formed therein, and a removable outer skin glove that is removably disposable over at least a portion the inner core. The inner core is fabricated of a flexible and translucent material having a durometer of between 10 and 30 on the Shore A scale. The outer skin glove is fabricated of a flexible and translucent material having a durometer of between 00-10 and 00-30 on the Shore 00 scale, and flexion and extension properties such that outer skin glove is ‘self-concealing’ of puncture holes. In such embodiments the system additionally comprises at least one flexible blood vessel tubing that is removably disposable within the at least one blood vessel channel. The blood vessel tubing fabricated of a material that has flexion and extension properties such that blood vessel tubing is ‘self-concealing’ of puncture holes. In such embodiments the system further comprises a fluid supply module that includes a fluid reservoir, and a dispensing tube connectable to the fluid reservoir. In such embodiments the system still further comprises a pump that is removably connectable to a dispensing tube and the blood vessel tubing.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The drawings described herein are for illustration purposes only and are not intended to limit the scope of the present teachings in any way.

FIG. 1A is an exemplary illustration of a neonate intravascular (IV) task trainer system, in accordance with various embodiments of the present disclosure.

FIG. 1B is an exemplary illustration of the neonate intravascular (IV) task trainer system shown in FIG. 1A including a pump, in accordance with various embodiments of the present disclosure.

FIG. 2 is an exemplary illustration of a neonate IV training module of the IV task trainer system shown in FIG. 1 exemplarily illustrated to replicate a neonate arm in a fully assembled state, in accordance with various embodiments of the present disclosure.

FIG. 3 is an exemplary illustration of the neonate IV training module shown in FIG. 2 having an outer skin glove partially rolled back over an inner core and having blood vessel tubing disposed within vessel circuit channels of the IV training module, in accordance with various embodiments of the present disclosure.

FIG. 4 is an exemplary illustration of the neonate IV training module shown in FIGS. 2 and 3 having the outer skin glove completely removed from the inner core and showing the blood vessel tubing channel circuit having the blood vessel tubing disposed therein, wherein the blood vessel tubing channel circuit emulates the location of various blood vessels within a neonate arm which would be used for insertion of an IV catheter, in accordance with various embodiments of the present disclosure.

FIG. 5 is an exemplary illustration of the neonate IV training module shown in FIGS. 2-4 having an outer skin glove removed from the inner core and showing the blood vessel tubing channel circuit having the blood vessel tubing removed, in accordance with various embodiments of the present disclosure.

FIG. 6 is an exemplary illustration of a neonate IV training module of the IV task trainer system shown in shown in FIG. 1 exemplarily illustrated to replicate a neonate leg in a fully assembled state, in accordance with various embodiments of the present disclosure.

FIG. 7 is an exemplary illustration of the neonate IV training module shown in FIG. 7 having an outer skin glove partially rolled back over an inner core and having blood vessel tubing disposed within vessel circuit channels of the IV training module, in accordance with various embodiments of the present disclosure.

FIG. 8 is an exemplary illustration of the neonate IV training module shown in FIGS. 6 and 7 having the outer skin glove completely removed from the inner core and showing a front side of the IV training module and a front side of the blood vessel tubing channel circuit having the blood vessel tubing disposed therein, wherein the blood vessel tubing channel circuit emulates the location of various blood vessels within the front side of a neonate leg which would be used for insertion of an IV catheter, in accordance with various embodiments of the present disclosure.

FIG. 9 is an exemplary illustration of the neonate IV training module shown in FIGS. 6-8 having the outer skin glove completely removed from the inner core and showing a back side of the IV training module and a back side of the vessel tubing channel circuit having the blood vessel tubing disposed therein, wherein the blood vessel tubing channel circuit emulates the location of various blood vessels within the back side of a neonate leg which would be used for insertion of an IV catheter, in accordance with various embodiments of the present disclosure.

FIG. 10 is an exemplary illustration of a neonate IV training module of the IV task trainer system shown in shown in FIG. 1 exemplarily illustrated to replicate a neonate head in a fully assembled state, in accordance with various embodiments of the present disclosure.

FIG. 11 is an exemplary illustration of the neonate IV training module shown in FIG. 10 having an outer skin glove partially rolled back over an inner core and having blood vessel tubing disposed within vessel circuit channels of the IV training module, in accordance with various embodiments of the present disclosure.

FIG. 12 is an exemplary illustration of the neonate IV training module shown in FIGS. 10 and 11 having the outer skin glove completely removed from the inner core and showing the blood vessel tubing channel circuit having the blood vessel tubing disposed therein, wherein the blood vessel tubing channel circuit emulates the location of various blood vessels within a neonate head which would be used for insertion of an IV catheter, in accordance with various embodiments of the present disclosure.

FIG. 13 is a cross-sectional view of a portion of the inner core of the neonate trainer module shown in FIGS. 1-12 exemplarily illustrating a blood vessel tubing channel having retention lip, tab or flap that is structured and operable to retain the blood vessel tubes within the blood vessel tubing channels, in accordance with various embodiments of the present disclosure.

FIG. 14 is a cross-sectional view of a portion of the inner core of the neonate trainer module shown in FIGS. 1-13 exemplarily illustrating a blood vessel tubing channel having a blood vessel tube retained therein by the retention lip, tab or flap, in accordance with various embodiments of the present disclosure.

FIGS. 15A and 15B exemplarily illustrate the ability of the neonate IV training module shown in FIGS. 1 through 5 to be hyperflexed at the wrist to allow trainees to practice a hyperflexion technique for IV needle insertion, in accordance with various embodiments of the present disclosure.

FIGS. 16A and 16B exemplarily illustrate the ability of the neonate IV training module shown in FIGS. 1 through 5 to be plantarflexed at the ankle to allow trainees to practice a plantarflexion technique for IV needle insertion, in accordance with various embodiments of the present disclosure

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts are causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

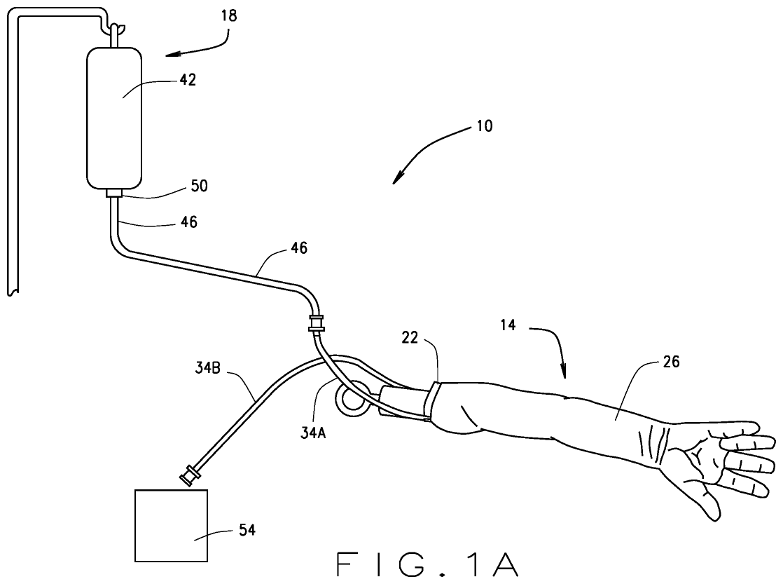

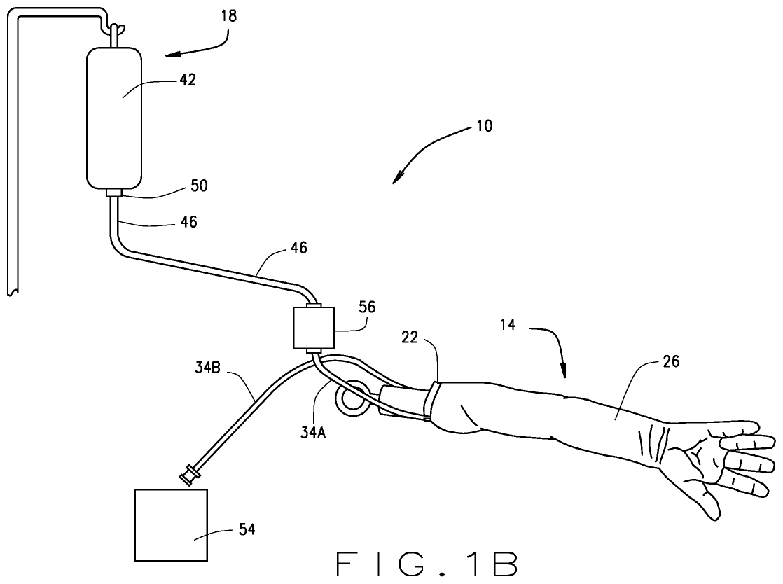

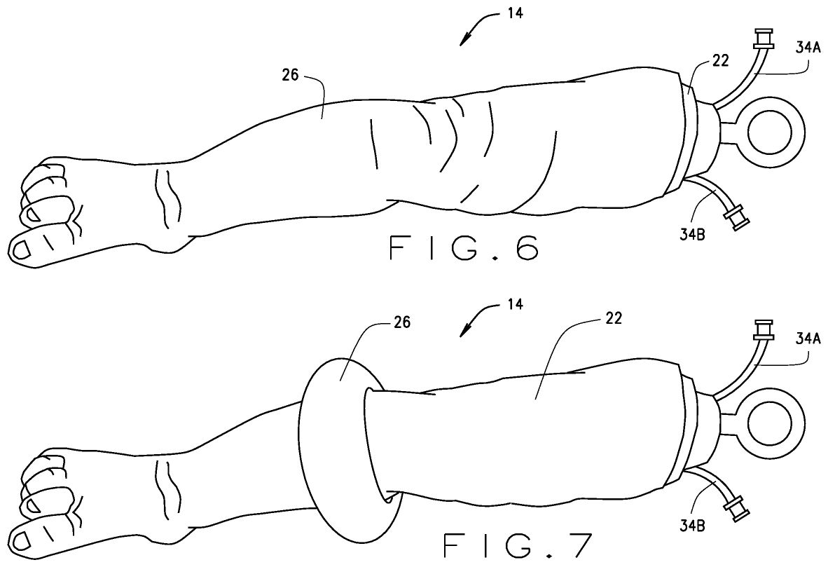

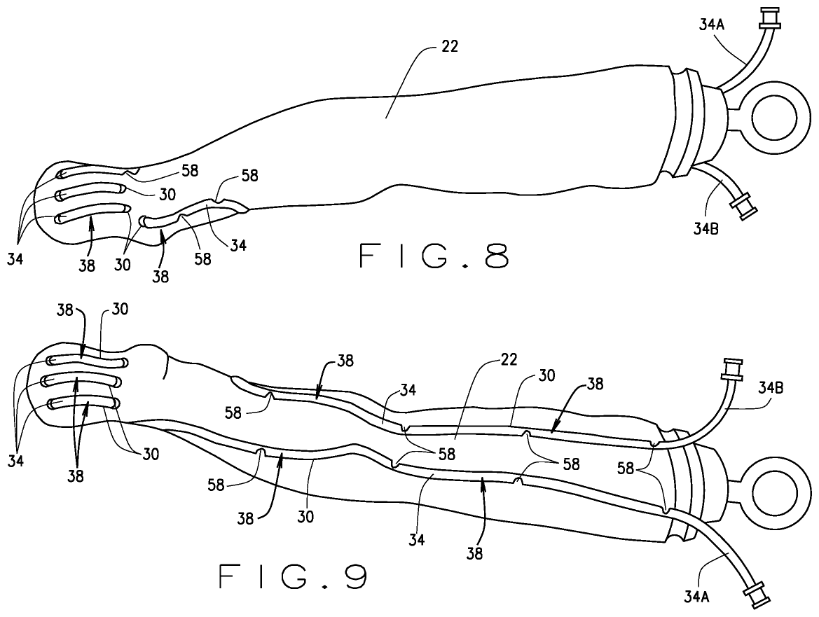

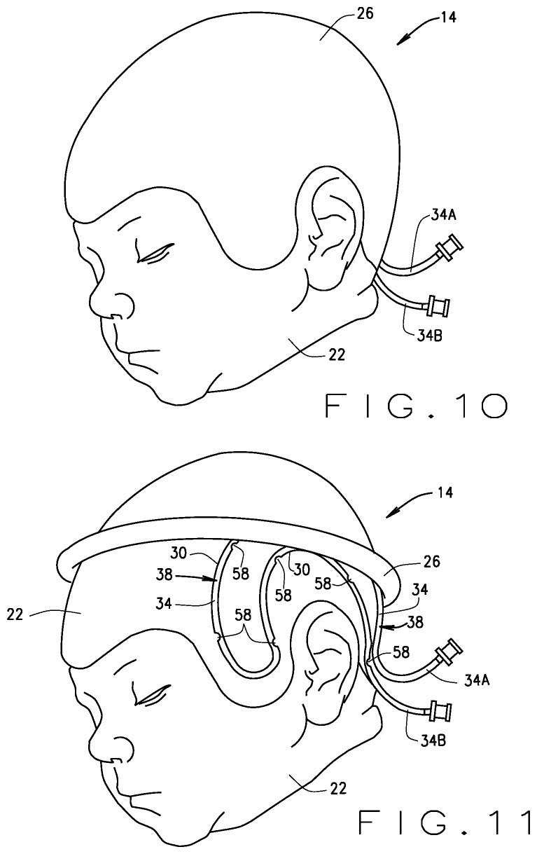

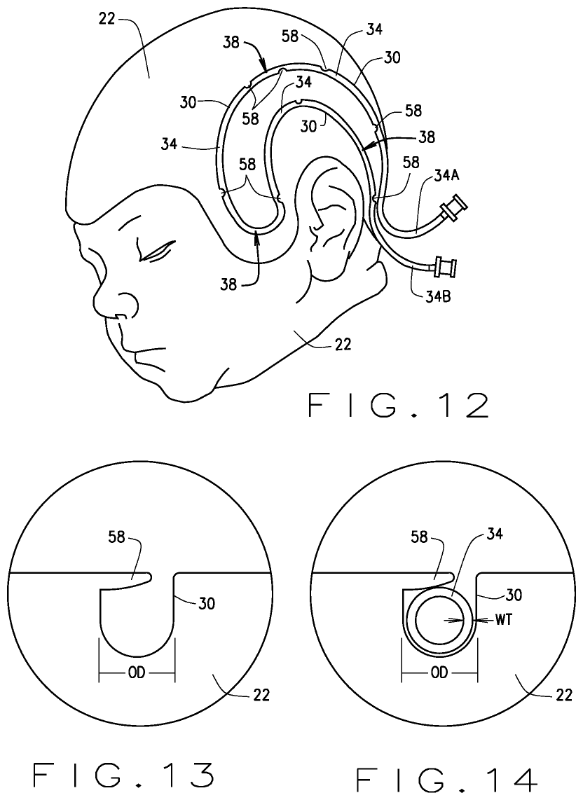

Referring to FIG. 1A, the present disclosure generally provides an interactive educational neonate intravenous (IV) task trainer system 10 for practicing critical nursing skills such as, IV catheterization, IV flush, IV dressing administration, transillumination of vessels, PICC line insertion, and arterial blood gas sampling on neonates. In various embodiments, the neonate IV task trainer system comprises one or more neonate IV training module 14 and a fluid supply module 18 that is removably and fluidly connectable to the IV training module 14. The IV training module 14 is fabricated and constructed to anatomically replicate an appendage of a neonate that comprises blood vessels (arterial and/or venous) that are commonly used by medical professionals for such things as IV catheterization, IV flush, transillumination of vessels, PICC line insertion, and arterial blood gas sampling on neonates. For example, although the IV training module 14 is exemplarily shown in FIGS. 1A and 1B as an analog of a neonate arm, in various embodiments the IV training module 14 could be an analog of a neonate leg, as exemplarily illustrated in FIGS. 6 through 9, or an analog of a neonate head, as exemplarily illustrated in FIGS. 10 through 12, and remain within the scope of the present disclosure. As used herein the terms ‘analog’ and ‘anatomically replicate’ will be understood to mean that the IV training module is fabricated and constructed to replicate and/or emulate and/or simulate the respective neonate appendage with regard to size, appearance (i.e., color, shape size, etc.), tactility, density, flexibility, resilience, weight, durometer and translucence.

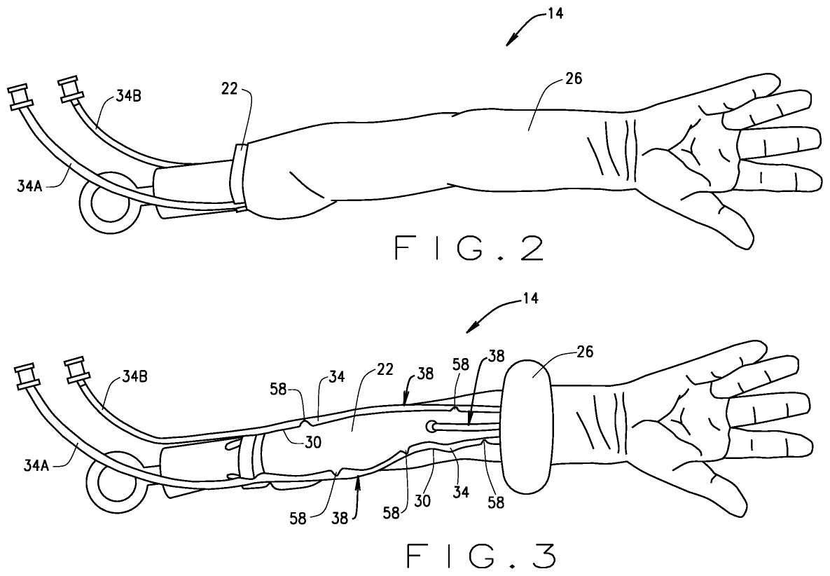

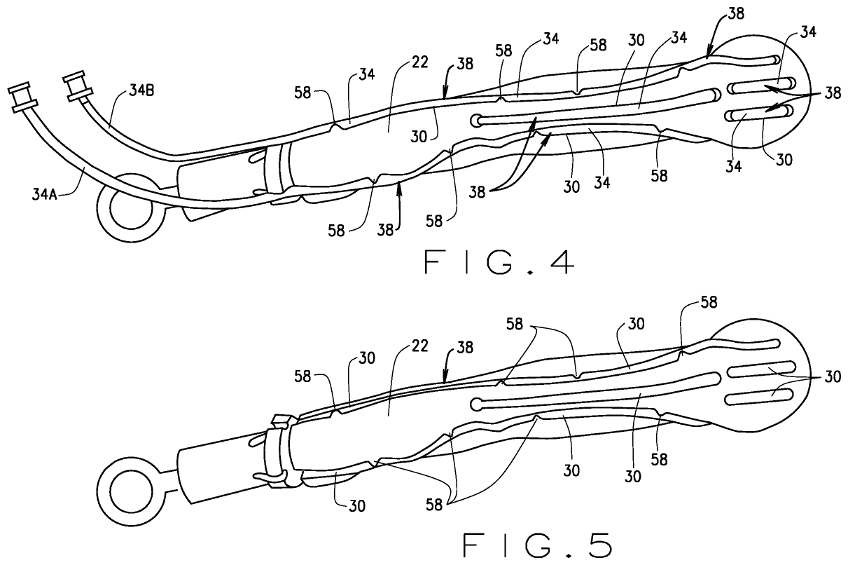

Referring now to FIGS. 1A through 12, each IV training module 14 generally comprises an inner core 22 and a removable and replaceable ultra-thin outer skin glove 26 that is disposable over and tightly fits on, over, and envelops at least a portion the inner core 22. The inner core 22 includes one or more shallow blood vessel channel(s) 30 formed therein. The shape, length, layout, course, and path of the blood vessel channel(s) 30 within the inner core 22 correspond(s) to the shape, length, layout, course, and path of the blood vessel circuit of the typical human neonate vascular anatomy (including both arterial and/or venous blood vessels) with the respective appendage. The IV training module 14 additionally comprises one or more flexible blood vessel tubing 34 that is removably and replaceably disposable within the blood vessel channel(s) 30. The blood vessel tubing 34 fabricated and constructed to anatomically replicate the blood vessels of a neonate. The channel(s) 30 with the tubing 34 disposed therein is generally referred to herein as the blood vessel circuit 38 of the IV training module 14. Hence, the blood vessel circuit 38 accurately correspond(s) to the shape, length, layout, course, and path of the blood vessel circuit of a typical human neonate vascular anatomy (including both arterial and/or venous blood vessels) of the respective appendage. For example, in various embodiments wherein the IV training module 14 is an analog of a neonate arm, the blood vessel circuit 38 can include one or more of: the dorsal arch veins, the cephalic vein, the basilic vein, the median antecubital vein, the veins within the volar aspect of the wrist, and/or the radial artery. Or, for example, in various embodiments wherein the IV training module 14 is an analog of a neonate leg, the blood vessel circuit 38 can include one or more of: the dorsal arch veins, the saphenous of the ankle, the saphenous of the leg and/or the posterior tibial artery. Or, for example, in various embodiments wherein the IV training module 14 is an analog of a neonate head, the blood vessel circuit 38 can include one or more of: the superficial temporal vein and/or medial scalp veins.

In various embodiments, the tubing 34 can be configured and disposed within the inner core channel(s) 30 as a single circuit representing a neonate venous circuit or a neonate arterial vasculature circuit, while in other embodiments, the tubing 34 can be configured and disposed within the inner core channel(s) 30 as two or more separate circuits, e.g., one circuit representing a neonate venous circuit and separate and independent circuit representing a neonate arterial vasculature circuit. The blood vessel tubing 34 is fabricated and constructed to anatomically emulate the structure of the actual blood vessels within respective neonate appendage (e.g., neonate arm, leg or head). More specifically, the blood vessel tubing 34 is fabricated and constructed to be an analog of and emulate the structure of the actual blood vessels within the respective neonate appendage with regard to wall thickness, appearance (i.e., color, shape size, etc.), tactility, density, flexibility, resilience, weight, durometer and translucence. For example, as shown in FIG. 14, the blood vessel tubing 34 has on outside diameter OD and a wall thickness WT that is substantially equivalent to the outside diameter and wall thickness of the typical neonate blood vessel. For example, in various embodiments, the blood vessel tubing 34 has on outside diameter OD of between 1 and 3 mm, and a wall thickness WT of between 0.70 and 0.90 mm, e.g., 0.80 mm. In various embodiments, the tubing 34 can be fabricated from any material such that the tubing 34 has the wall thickness, density, flexibility, translucency, and durometer of the actual blood vessels of a neonate. For example, in various embodiments the tubing 34 can be fabricated of latex. Alternatively, in various other embodiments, the tubing 34 can be fabricated of silicone or any other material that will provide the tubing 34 with the thickness, density, flexibility, translucency, and durometer of the blood vessels of a neonate.

The fluid supply module 18 comprises a fluid reservoir or container 42 such as a bag, pouch or bottle, or any other reservoir or container that is structured and operable to retain and dispense a fluid. The fluid supply module 18 additionally comprises a dispensing tube 46 that is fluidly connected or removably connectable at a first end to a dispensing outlet 50 of the fluid reservoir 42 such that a fluid disposed within the fluid reservoir 42 can be dispensed from the fluid reservoir 42 via the dispensing outlet 50 and dispensing tube 46. Furthermore, the dispensing tube 46 is structured and operable to be removably connectable at a second end (i.e., opposite end from the first end) to an inlet end 34A of the IV training module tubing 34, such that the fluid disposed within the fluid reservoir 42 can be dispensed from the fluid reservoir 42 and flow through the IV training module tubing 34, i.e., through the IV training module blood vessel circuit 38, and exit the IV training module tubing 34 via an outlet end 34B. The outlet end 34B can be removably connectable to or disposable in any suitable fluid collection reservoir 54, such as a bag, pouch, bottle, bucket, jar, sink, etc.

It is envisioned that the fluid reservoir 42 can be filled with simulated blood that flows into, is dispensed into, or is pumped into, the IV training module tubing 34 such that the simulated blood flows through the IV training module blood vessel circuit 38 where it is accessible via proper insertion of an IV needle through the IV training module outer skin glove 26 (i.e., outer skin 26) into the tubing 34 as described below. For example, in various embodiments, the fluid reservoir 42 can be suspended above the respective training module 14, whereby gravitational forces will cause the simulated blood to flow from the fluid reservoir 42, through the IV training module blood vessel circuit 38, and exit the blood vessel circuit 38 into the fluid collection reservoir 54. Additionally, as controlled by controlling the height at which the fluid reservoir 42 is suspended above the IV training module 14, the gravitational forces will provide pressure within the blood vessel circuit 38 (e.g., simulated venous pressure). Particularly, the higher the fluid reservoir 42 is suspended above the IV training module 14, the great the pressure of the fluid flowing within the blood vessel circuit 38, and vice-versa.

Alternatively, in various embodiments, the system 10 can include a pump 56, e.g., a low-pressure pump, (as exemplarily shown in FIG. 1B), wherein the fluid reservoir 42, more particularly the dispensing tube 46 and the IV training module tubing 34 are removably connectable to the pump 56. The pump 56 is structured and operable to provide a desired and controlled pressure within the blood vessel circuit 38. For example, in various instances, a peristaltic pump can be connected to the dispensing tube 46 and the IV training module tubing 34 to simulate an arterial vasculature circuit, and is structured and operable to provide pulsatile pressure within the blood vessel circuit 38 of the IV training module 14. Therefore, a neonate pulse can be simulated such that a trainee can confirm the correct location in which to insert an IV needle by feeling for the pulse. If no pulse is felt, the trainee should understand that they have not yet located the simulated artery.

The pressure provided within the blood vessel circuit 38 is essential in offering the trainee a realistic passive flow of blood through an IV catheter as would be seen and experienced in a real patient. Particularly, by providing blood vessel tubing 34 that has substantially the same thickness, density rigidity, and durometer as real neonate blood vessels, and by providing realistic blood pressure within the blood vessel tubes 34 of the blood vessel circuit 38 the trainee gets immediate haptic feedback. For example, the trainee can feel when the IV needle penetrates the wall of the blood vessel tubing 34, and will get a ‘flash back of blood’ within the IV needle when the IV needle penetrates the wall and enters the lumen of the respective of the blood vessel tube 34. Such haptic feedback will provide the trainee with immediate feedback so the trainee will know right away if they are performing the procedure correctly or incorrectly. As described above, the blood vessel tubing 34 is fabricated or constructed to have a wall thickness, appearance, tactility, density, flexibility, resilience, weight, durometer and translucence such that the blood vessel circuit 38 is an analog of real neonate blood vessels. Furthermore, in various embodiments, the blood vessel tubing 34 is fabricated from any material (e.g., latex) such that the blood vessel tubing 34 is ‘self-concealing’ of puncture holes made by IV needles. That is, the low-durometer material used to fabricate the blood vessel tubing 34 has flexion and extension properties, characteristics, or traits that are convincingly similar to real neonate blood vessels such that the blood vessel tubing 34 will not deform when pierced by and IV needle such that the blood vessel tubing 34 can be pierced with an IV needle and then after the IV needle is withdrawn, removed or extracted the material properties of the blood vessel tubing 34 will cause the hole in to contract, close and seal such that the hole will not leak and will prevent the fluid flowing therewithin to from escape. Hence, the blood vessel tubes 34 can be pierced with IV needles numerous times (e.g., hundreds of times) without showing the location of the piercings, or punctures, thereby giving no indication to a subsequent trainee where prior trainees have inserted an IV needle.

As described above, the outer skin glove 26 is removably disposable over at least a portion the inner core 22 such that it fits tightly over the inner core 22, thereby tightly enveloping the inner core 22 and blood vessel tubing 34 disposed within the blood vessel channel(s) 30. The inner core 22 is fabricated and constructed to anatomically emulate the musculoskeletal structure of respective neonate appendage (e.g., neonate arm, leg or head). More specifically, the inner core 22 is fabricated and constructed to be an analog of and emulate the appearance (i.e., color, shape size, etc.), tactility, density, flexibility, resilience, weight, durometer and translucence the muscle and bone of the respective neonate appendage with regard to. For example, in various embodiments, the inner core 22 can be fabricated from premium low-durometer silicone (e.g., premium low-durometer platinum-cured or tin-cured silicone). In various instances, the inner core 22 can be fabricated from premium low-durometer silicone having a durometer of between 10 and 30, e.g., 20, on the Shore A scale. Similarly, the outer skin glove 26 is fabricated and constructed to anatomically emulate the thin, delicate, translucent skin of skin of the respective neonate appendage (e.g., neonate arm, leg or head). More specifically, the outer skin glove 26 is fabricated and constructed to be an analog of and emulate the structure of skin of the respective neonate appendage with regard to appearance (i.e., color, shape size, etc.), tactility, density, flexibility, resilience, weight, durometer and translucence. For example, in various embodiments, the outer glove/skin can be fabricated from premium low-durometer silicone (e.g., premium low-durometer platinum-cured or tin-cured silicone). In various instances, the outer skin glove 26 can be fabricated from premium low-durometer silicone having a durometer of between 00-10 and 00-30, e.g., 00-20, on the Shore 00 scale.

More particularly, in various instances, the outer skin glove 26 can be fabricated or composed of a low-durometer soft premium silicone rubber such that the outer skin glove 26 is ‘self-concealing’ of puncture holes made by IV needles. That is, the low-durometer soft premium silicone rubber outer skin glove 26 has flexion and extension properties, characteristics, or traits that are convincingly similar to real neonate skin such that it will not deform when pierced by and IV needle such that the outer skin glove 26 can be pierced with an IV needle and then after the IV needle is withdrawn, removed or extracted the material properties of the silicone rubber will cause the hole in outer skin glove 26 to contract and close such that the hole, and the location thereof, is invisible to the human eye. Hence, the outer skin glove 26 can be pierced with IV needles numerous times (e.g., hundreds of times) without showing the location of the piercings, or punctures, thereby giving no indication to a subsequent trainee where prior trainees have inserted an IV needle. Additionally, the cured silicone rubber of the inner core 22 and the outer skin glove 26 is non-toxic, chemically inert, easily cleaned, and stable, such that it will not stain or discolor from and dye that may be in the simulated blood flowing through the blood vessel circuit 38 that may leak around the IV needle with the IV needle is inserted through the outer skin glove 26 and into the lumen of the blood vessel tubing 34.

Furthermore, and importantly, the low-durometer soft premium silicone rubber of the inner core 22 and outer skin glove 26 is translucent and semi-transparent such that light projected onto one portion or side of the IV training module 14 will illuminate at least a portion of the IV training module 14 whereby at least a portion of the interior mass and structure of the inner core 22 and outer skin glove 26 will be illuminated and visible. Therefore, light can be projected on one portion or side of the IV training module 14 to illuminate a portion of the interior mass and structure of IV training module 14. Hence, a trainee can see through the outer skin glove 26 and see below the layer of the outer skin glove 26 whereby the location and disposition of the blood vessel tubes 34 and circuit 38 beneath the outer skin glove 26 are visible and can be easily identified to assist trainees in learning proper IV insertion techniques in neonates. More specifically, the IV training module 14 is structured and operable to allow trainees to simulate and use a well-known transillumination method of identifying the location and disposition of blood vessels in neonates. Transillumination, is a test performed in a dark room, with a bright light shined at a specific body part to see the structures beneath the skin, and is often performed in the neonatal patient population, because the very small vessels are difficult to see and palpate unaided.

Another advantage of the fabricating and constructing the inner core 22 and outer skin glove 26 of the low-durometer soft premium silicone rubber is that the translucent silicone can be colored or augmented through the addition of pigments and additives in its uncured liquid stage to achieve a highly convincing human tissue analogue, which cannot be done with alternative materials, such as polyurethanes. The addition of pigments at the uncured casting stage allows for significant color and translucence, or semitransparency, thereby allowing personalization and customization of varying skin tones, which, in addition to aesthetic enhancement, can provide various realistic grades of translucence in the respective IV training module 14 that emulates various skin tones. For example, by reducing the amount of pigmentation and thereby increasing the translucency, hyper-realistic neonatal outer skin gloves 26 can be fabricated, thereby simulating actual neonate features trainees can expect on a living patient when attempting difficult catheterizations on neonates and premature infants.

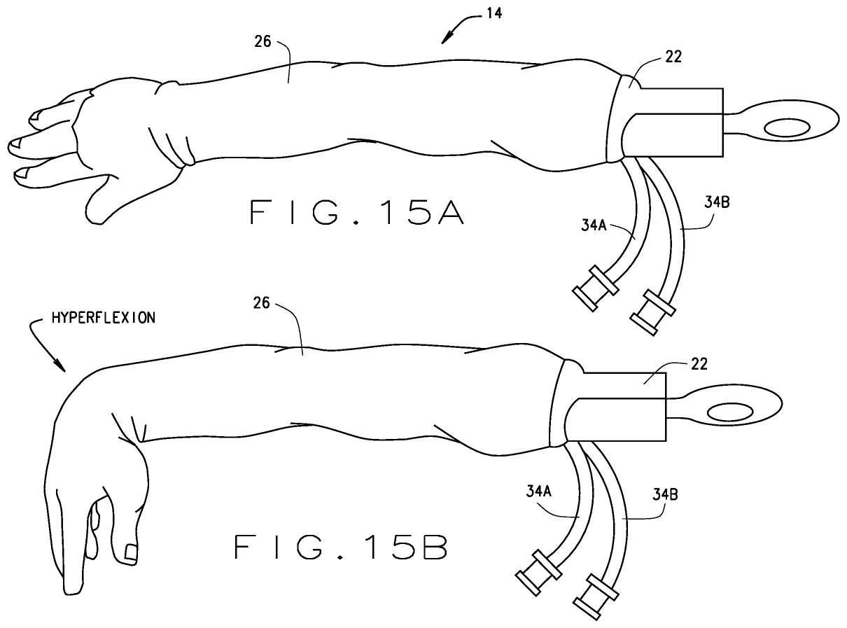

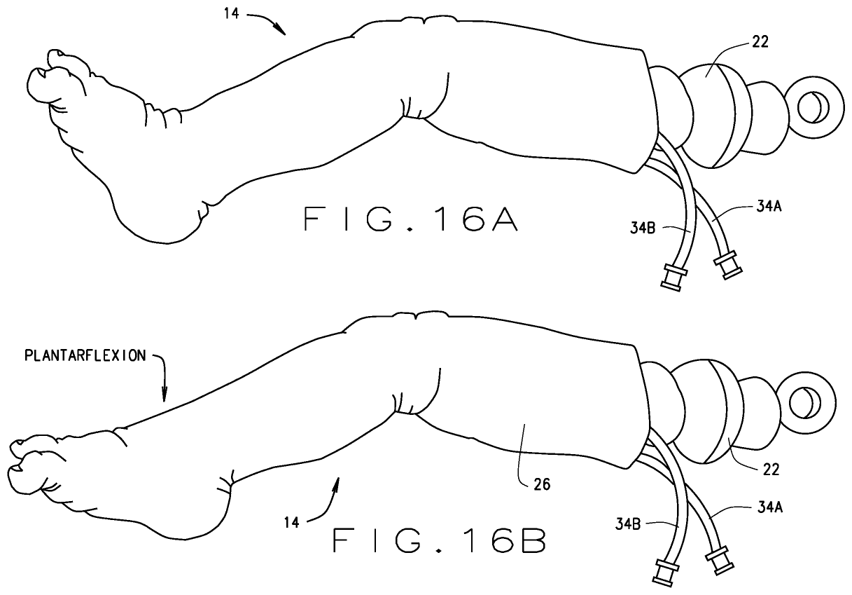

Referring now to FIGS. 15A, 15B, 16A and 16B, additionally, due to the inner core 22 and outer skin glove 26 being constructed or fabricated of soft low-durometer premium silicone rubber, the arm training module 14 allows for simulation of hyperflexion of the wrist, as exemplarily illustrated in FIG. 15B, a known method of hyper-flexing the wrist of a neonate to more easily identify the blood vessels therein and more easily insert an IV needle. Hence, the IV training module 14 can be hyper-flexed to increase the visibility of the blood vessel tubing 34 beneath outer skin glove 26 such that a trainee can more easily identify the location of the blood vessel tubing 34. Similarly, due to the inner core 22 and outer skin glove 26 being constructed or fabricated of soft low-durometer premium silicone rubber, the leg training module 14 allows for simulation of plantarflexion of the ankle, as exemplarily illustrated in FIG. 16B, a known method of hyper-plantar-flexing the ankle of a neonate to more easily identify the blood vessels therein and more easily insert an IV needle. Known IV training devices are incapable of providing hyperflexion and plantarflexion simulation. Hence, the IV training module 14 can be hyper-plantar-flexed to increase the visibility of the blood vessel tubing 34 beneath outer skin glove 26 such that a trainee can more easily identify the location of the blood vessel tubing 34.

Referring particularly to FIGS. 3, 4, 5, 8, 9, 11, 12, 13 and 14, in various embodiments, the blood vessel channels 30 formed in the surface the inner core 22 of the respective training module 14 have a width and depth that substantially equal to the outside diameter (OD) of the tubing to be disposed within the respective channel (e.g., approximately 1-3 mm) such that the blood vessel tubes 34 do not protrude above, and are substantially flush with, the top surface of the inner core 22, making it more difficult to be palpated by the trainee using the training module 14, and thus, more true to life. In various instances, different blood vessel channels 30 within the inner core 22 can have different widths and depths depending on the respective blood vessel tubing 34 to be disposed therein. In various embodiments, the blood vessel channels 30 can comprise a plurality of retention tabs 58 that extend over the top of the blood vessel channels 30 and are flush with the outer surface of the respective inner core 22. The retention tabs 58 are structured and operable to secure the blood vessel tubing 34 within the blood vessel channels 30 when the outer skin glove 26 is being installed over, or removed from, the inner core 22.

As exemplarily illustrated in FIGS. 3, 7 and 11, due to the flexibility and pliability of the outer skin glove 26, it is envisioned that in various embodiments, the outer skin glove 26 can be removed from the inner core 22 by rolling the outer skin glove 26 back on the inner core 22 into an annular roll similar to removing a latex finger cot from a finger. Once the outer skin glove 26 is removed the blood vessel tubing 26 can be removed and replaced. Thereafter, the outer skin glove 26 can be installed or disposed over or on the inner core 22 by rolling the outer skin glove 26 into and annular roll and then rolling the outer skin glove 26 over and onto the inner core 22 much like a finger cot is installed onto a finger.

The neonate IV task trainer system 10 disclosed herein offers instrumental and procedural fidelity unlike known IV training devices on the market. Particularly, the neonate IV task trainer system 10 disclosed herein provides realistic haptics that other known training devices do not. Hence, the neonate IV task trainer system 10 of the present disclosure provides a neonate IV training system that medical educators can place confidence in while validating the procedural skills of staff and students.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A neonate intravenous (IV) training module for practicing critical nursing skills, said training module comprising:
an inner core structured to have the size and shape of a neonate appendage, the inner core comprising at least one shallow blood vessel channel formed therein;
a removable outer skin glove structured to have the size and appearance of a neonate appendage, the outer skin glove being removably disposable over at least a portion the inner core; and
at least one flexible blood vessel tubing that is removably disposable within the at least one blood vessel channel, the at least one flexible tubing structure to have an outer diameter and wall thickness of a neonate blood vessel.

2. The system of claim 1, wherein the inner core is fabricated of a flexible material having a durometer of between 10 and 30 on the Shore A scale.

3. The system of claim 2, wherein the inner core is fabricated of a translucent material.

4. The system of claim 3, wherein the inner core is fabricated of silicone.

5. The system of claim 3, wherein the outer skin glove is fabricated of a flexible material having a durometer of between 00-10 and 00-30 on the Shore 00 scale.

6. The system of claim 5, wherein the outer skin glove is fabricated of a material that has flexion and extension properties such that outer skin glove is ‘self-concealing’ of puncture holes.

7. The system of claim 6, wherein the outer skin glove is fabricated of a translucent material.

8. The system of claim 7, wherein the outer skin glove is fabricated of silicone.

9. The system of claim 7, wherein the blood vessel tubing is fabricated of a flexible material that has flexion and extension properties such that outer skin glove is ‘self-concealing’ of puncture holes.

10. The system of claim 11, wherein the blood vessel tubing is fabricated of latex.

11. The system of claim 9, wherein the translucent inner core and the translucent outer skin glove are structured and operable to allow transillumination whereby the blood vessel tubing is visible through the outer skin glove when a light to be shined on the IV training module.

12. The system of claim 9, wherein the flexible inner core, the flexible outer skin glove, and the flexible blood vessel tubing are structured and operable to allow hyperflexion and plantarflex of the IV training module whereby the IV training module is hyper-flexed and hyper-plantar-flexed to increase the visibility of the blood vessel tubing beneath the outer skin glove.

13. The system of claim 1, wherein the blood vessel channels comprise a plurality of retention tabs structured and operable to retain the respective blood vessel tubing therein.

14. A neonate intravenous (IV) task trainer system for practicing critical nursing skills, said system comprising:
a neonate IV training module that is structured to have the size and appearance of neonate appendage, the IV training module comprises:
an inner core that comprises at least one shallow blood vessel channel formed therein; and
a removable outer skin glove that is removably disposable over at least a portion the inner core;
a fluid supply module that is removably and fluidly connectable to the IV training module; and
at least one flexible blood vessel tubing that is removably disposable within the at least one blood vessel channel, the at least one flexible tubing structure to have an outer diameter and wall thickness of a neonate blood vessel.

15. The system of claim 14 further comprising a pump that is removably connectable to a dispensing tube of the fluid supply module and the blood vessel tubing.

16. The system of claim 14, wherein the inner core is fabricated of a translucent, flexible material having a durometer of between 10 and 30 on the Shore A scale.

17. The system of claim 16, wherein the outer skin glove is fabricated of a translucent, flexible material having a durometer of between 00-10 and 00-30 on the Shore 00 scale, wherein the outer skin glove has flexion and extension properties such that outer skin glove is ‘self-concealing’ of puncture holes.

18. The system of claim 17, wherein the blood vessel tubing is fabricated of a flexible material that has flexion and extension properties such that outer skin glove is ‘self-concealing’ of puncture holes.

19. The system of claim 18, wherein the translucent inner core and the translucent outer skin glove are structured and operable to allow transillumination whereby the blood vessel tubing is visible through the outer skin glove when a light to be shined on the IV training module.

20. The system of claim 18, wherein the flexible inner core, the flexible outer skin glove, and the flexible blood vessel tubing are structured and operable to allow hyperflexion and plantarflex of the IV training module whereby the IV training module is hyper-flexed and hyper-plantar-flexed to increase the visibility of the blood vessel tubing beneath the outer skin glove.

21. A neonate intravenous (IV) task trainer system for practicing critical nursing skills, said system comprising:
a neonate IV training module that is structured to have the size and appearance of neonate appendage, the IV training module comprises:
an inner core that comprises at least one shallow blood vessel channel 30 formed therein, the inner core being fabricated of a flexible and translucent material having a durometer of between 10 and 30 on the Shore A scale; and
a removable outer skin glove that is removably disposable over at least a portion the inner core, the outer skin glove being fabricated of a flexible and translucent material having:
a durometer of between 00-10 and 00-30 on the Shore 00 scale; and
flexion and extension properties such that outer skin glove is ‘self-concealing’ of puncture holes;
at least one flexible blood vessel tubing that is removably disposable within the at least one blood vessel channel, the blood vessel tubing fabricated of a material that has flexion and extension properties such that blood vessel tubing is ‘self-concealing’ of puncture holes;
a fluid supply module comprising:
a fluid reservoir; and
a dispensing tube connectable to the fluid reservoir; and
a pump that is removably connectable to a dispensing tube and the blood vessel tubing.
